(19) United States
(12) Patent Application Publication
(10) Pub. No.: US 2024/0317119 A1
(43) Pub. Date: Sep. 26, 2024

(54) SEAT RECLINING DEVICE AND METHOD FOR MANUFACTURING SEAT RECLINING DEVICE

(71) Applicant: TF-METAL Co., Ltd., Kosai-shi (JP)

(72) Inventor: Kunihisa OISHI, Hamamatsu-shi (JP)

(73) Assignee: TF-METAL Co., Ltd., Kosai-shi (JP)

(21) Appl. No.: 18/604,061

(22) Filed: Mar. 13, 2024

(30) Foreign Application Priority Data
Mar. 24, 2023 (JP) 2023-047439

(51) Int. Cl. B60N 2/22

(52) U.S. Cl. CPC B60N 2/2213

(57) ABSTRACT

A seat reclining device includes: a first plate having internal teeth; a second plate overlaid on the first plate and having external teeth engaged with the internal teeth; and a holder having a cylindrical portion, an inner flange portion extending radially inwardly from one axial end of the cylindrical portion and opposed to the first (or second) plate and an outer flange portion extending radially outwardly from the other axial end of the cylindrical portion and welded to the second (or first) plate, wherein the outer circumferential portion of the second (or first) plate has a depressed part formed on a surface thereof facing the outer flange portion of the holder, and wherein the outer flange portion of the holder is welded to the outer circumferential portion of the second (or first) plate in a state of being pushed into the depressed part.

### BACKGROUND

The present invention relates to a seat reclining device and a method for manufacturing a seat reclining device.

Japanese Laid-Open Patent Publication No. 2006-204896 (hereinafter abbreviated as JP 2006-204896A) discloses a seat reclining device for adjusting the inclination angle of a seat back relative to a seat cushion, which includes: a circular first plate fixed to one of the seat cushion and the seat back; a circular second plate fixed to the other of the seat cushion and the seat back and opposed to the first plate; a pair of wedge-shaped members interposed between the first plate and the second plate; and a cam arranged to slide the wedge-shaped members in a direction away from each other. In JP 2006-204896A, the diameter of the second plate is set larger than the diameter of the first plate so that, in the state where the first plate and the second plate are opposed to each other, an outer circumferential portion of the second plate is located radially outward of an outer circumferential portion of the first plate. Further, the first plate is disposed movably relative to the second plate.

The seat reclining device of JP 2006-204896A also includes a ring-shaped holder arranged adjacent to the outer circumferential portions of the first and second plates and adapted to restrict separation of the first plate away from the second plate. The holder has: a cylindrical portion extending in an axial direction along the center axis of the first plate; an inner flange portion extending radially inwardly from one axial end of the cylindrical portion and opposed to the first plate via a slight clearance so as to restrict separation of the first plate from the second plate; and an outer flange portion extending radially outwardly from the other axial end of the cylindrical portion and fixed by laser welding to the outer circumferential portion of the second plate.

### SUMMARY

In the seat reclining device of JP 2006-204896A, the laser welding needs to be performed, with no clearance left between the outer circumferential portion of the second plate and the outer flange portion of the holder, in order to suppress the generation of spatter during the laser welding and to stably weld the holder and the second plate together.

In the seat reclining device of JP 2006-204896A, on the other hand, there is generally a slight clearance left between an inner circumferential surface of the inner flange portion of the holder and an outer circumferential surface of the outer circumferential portion of the first plate, in order to restrict the first plate from being separated away from the second plate while allowing rotation of the first plate relative to the second plate.

Furthermore, the manufacturing site of the seat reclining devices involves mass production of the first plates, second plates and holders etc., which naturally leads to dimensional variations of these respective device parts. In addition, the assembling of the first and second plates can cause inclinations of the first and second plates from their respective predetermined assembling positions due to assembling errors.

The above-mentioned dimensional variation problem and/or inclination problem raises the possibility that, when trying to ensure a slight clearance between the inner flange portion of the holder and the outer circumferential portion of the first plate, there appears a clearance between the outer circumferential portion of the second plate and the outer flange portion of the holder whereby the laser welding of the holder and the second plate may not be performed stably.

It is accordingly difficult to achieve both of fixing the outer circumferential portion of the second plate and the outer flange portion of the holder by laser welding with no clearance left therebetween and ensuring the slight clearance between the inner circumferential surface of the inner flange portion of the holder and the outer circumferential surface of the outer circumferential portion of the first plate.

The present invention has been made in view of the foregoing circumstances. It is an object of the present invention to provide a seat reclining device capable of ensuring a slight clearance between the outer circumferential portion of the first plate and the inner flange portion of the holder while stably fixing the outer flange portion of the holder by welding to the outer circumferential portion of the second plate. It is also an object of the present invention to provide a method for manufacturing such a seat reclining device.

According to one aspect of the present invention, there is provided a seat reclining device comprising:
a first plate having a plurality of internal teeth formed in an axial direction on an annular inner circumferential surface thereof;
a second plate overlaid on the first plate and having a plurality of external teeth formed on an annular outer circumferential surface thereof and engaged with the internal teeth, a number of the external teeth being smaller by one or two than a number of the internal teeth;
a ring-shaped holder fixed by welding to an outer circumferential portion of one of the first and second plates, while being opposed to an outer circumferential portion of the other of the first and second plates in the axial direction, so as to restrict separation of the other of the first and second plates from the one of the first and second plates; and
an eccentric drive mechanism eccentrically rotatable to change a position of engagement of the internal teeth and the external teeth and thereby cause rotation of the other of the first and second plates relative to the one of the first and second plates,
the holder comprising: a cylindrical portion extending in the axial direction; an inner flange portion extending radially inwardly from one axial end of the cylindrical portion and opposed to the other of the first and second plates; and an outer flange portion extending radially outwardly from the other axial end of the cylindrical portion and welded to the one of the first and second plates,
wherein the outer circumferential portion of the one of the first and second plates has, formed on a surface thereof opposed to and facing the outer flange portion of the holder, a depressed part inclined in such a manner that a distance from the holder to the depressed part in the axial direction increases toward a radially inner side, and
wherein the outer flange portion of the holder is welded to the outer circumferential portion of the one of the first and second plates in a state of being pushed into the depressed part.

According to another aspect of the present invention, there is provided a manufacturing method of a seat reclining device,
the seat reclining device comprising:
a first plate having a plurality of internal teeth formed in an axial direction on an annular inner circumferential surface thereof;
a second plate overlaid on the first plate and having a plurality of external teeth formed on an annular outer circumferential surface thereof and engaged with the internal teeth, a number of the external teeth being smaller by one or two than a number of the internal teeth;
a ring-shaped holder fixed by welding to an outer circumferential portion of one of the first and second plates, while being opposed to an outer circumferential portion of the other of the first and second plates in the axial direction, so as to restrict separation of the other of the first and second plates from the one of the first and second plates; and
an eccentric drive mechanism eccentrically rotatable to change a position of engagement of the internal teeth and the external teeth and thereby cause rotation of the other of the first and second plates relative to the one of the first and second plates,
the holder comprising: a cylindrical portion extending in the axial direction; an inner flange portion extending radially inwardly from one axial end of the cylindrical portion and opposed to the other of the first and second plates; and an outer flange portion extending radially outwardly from the other axial end of the cylindrical portion and welded to the one of the first and second plates,
the manufacturing method comprising:
pushing the outer flange portion of the holder toward the outer circumferential portion of one of the first and second plates; and
welding the outer flange portion of the holder to the outer circumferential portion of the one of the first and second plates,
wherein the outer circumferential portion of the one of the first and second plates has, formed on a surface thereof opposed to and facing the outer flange portion of the holder, a depressed part inclined in such a manner that a distance from the holder to the depressed part in the axial direction increases toward a radially inner side,
wherein the pushing is performed to push the outer flange portion into the depressed part, and
wherein the welding is performed in a state that the outer flange portion is pushed into the depressed part.

The present invention ensures a slight clearance between the outer circumferential portion of the first plate and the inner flange portion of the holder while enabling stable welding of the outer flange portion of the holder to the outer circumferential portion of the second plate.

The other objects and features of the present invention will also become understood from the following description.

### BRIEF DESCRIPTION OF DRAWINGS

FIG. 1 is an exploded perspective view of a seat reclining device according to a first embodiment of the present invention.

FIG. 2 is a sectional view of a main part of the seat reclining device according to the first embodiment of the present invention.

FIG. 3 is a sectional view of a part of the seat reclining device, in the vicinity of an outer circumferential portion of a second plate, according to the first embodiment of the present invention.

FIGS. 4A and 4B are respectively schematic views of an arrangement step and a pushing/welding step in a manufacturing process of the seat reclining device according to the first embodiment of the present invention.

FIG. 5 is a sectional view of a seat reclining device, in the vicinity of an outer circumferential portion of a second plate, according to a second embodiment of the present invention.

### DETAILED DESCRIPTION

Hereinafter, exemplary embodiments of the present invention will be described in detail with reference to the drawings, in which like parts and portions are designated by like reference numerals.

A seat reclining device according to the first embodiment of the present invention will be now explained below.

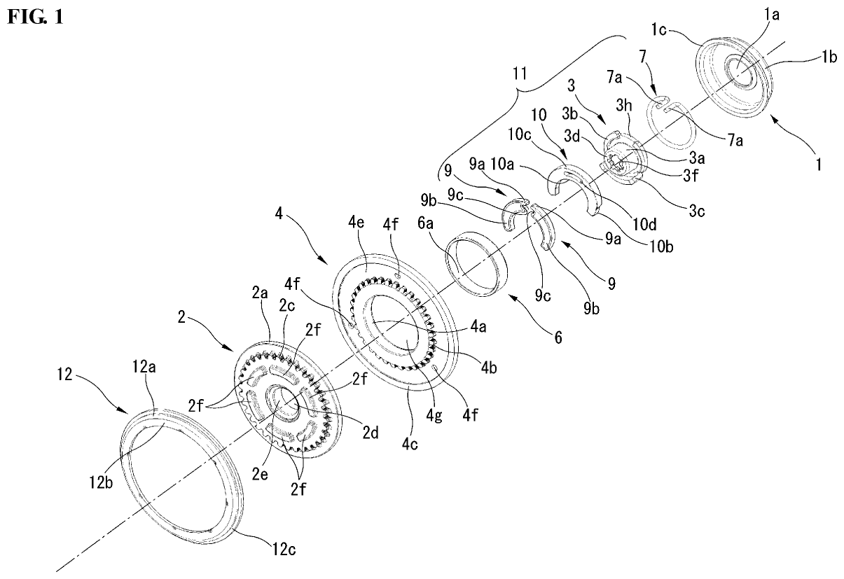

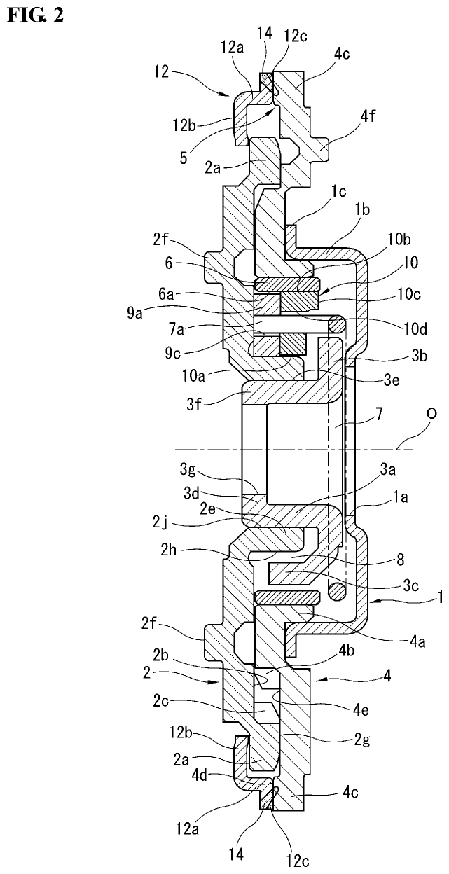

FIG. 1 is an exploded perspective view of the seat reclining device according to the first embodiment of the present invention; and FIG. 2 is a sectional view of a main part of the seat reclining device according to the first embodiment of the present invention.

As shown in FIGS. 1 and 2, the seat reclining device according to the first embodiment includes: a first plate 2 (as an internally toothed gear member) coupled to a seat back-side arm of a seat back; a second plate 4 (as an externally toothed gear member) coupled to a seat cushion-side arm of a seat cushion; a drive bushing 3 (as a drive member) mounted on and rotatable with a drive shaft (output shaft) which is rotationally driven by an electric motor disposed on the seat back side; a cover member 1 integrally coupled to the second plate 4 so as to cover the outer side of the drive bushing 3; and a holder 12 arranged to hold the first plate 2 in position relative to the second plate 4. When the drive bushing 3 is rotated in a normal rotation direction or a reverse rotation direction with the application of a rotational drive force by the electric motor, the rotation of the drive bushing 3 is reduced at a high reduction ratio by and transmitted to the first and second plates 2 and 4 so that the first plate 2 is rotated relative to the second plate 4 in a direction opposite to the rotation direction of the drive bushing 3.

The first plate 2 is made of an iron-based metal material in a circular plate shape, with a through hole 2d formed through the center of the first plate 2. The first plate 2 has an outer circumferential portion 2a and an annular recess portion 2b formed radially inward of the outer circumferential portion 2a. A plurality of internal teeth 2c are formed by half blanking in the axial direction on an inner circumferential surface of the annular recess portion 2b. Further, the first plate 2 has a cylindrical boss portion 2e formed integrally extending from a hole edge of the through hole 2d toward the second plate 4 side along the axial direction of the first plate 2. A plurality of protrusions (in the first embodiment, six protrusions) 2f are provided at circumferentially equally spaced positions on a part of the first plate 2 between the internal teeth 2c and the boss portion 2e so as to protrude toward the seat back-side arm. In the first embodiment, the protrusions 2f are press-formed by embossing such that these protrusions are respectively fitted in and welded to six fixing holes of the seat back-side arm.

The second plate 4 is made of an iron-based metal material in an annular shape. The second plate 4 has an annular flange portion 4a formed in a center part thereof, with a diameter sufficiently larger than that of the boss portion 2e of the first plate 2, and protruding toward the cover member 1 side. A large-diameter hole 4g defined by an inner circumferential surface of the annular flange portion 4a serves as a mounting hole. A plurality of external teeth 4b are formed by half blanking on a radially middle region of an outer circumferential surface of the annular flange portion 4a so as to be engageable with the internal teeth 2c of the first plate 2. In the first embodiment, the number of the external teeth 4b is set smaller by one or two than the number of the internal teeth 2c. With this setting, the center of the second plate 4 is eccentric to the center (center line O) of the first plate 2 so that a part of the second plate 4 in the circumferential direction is brought into engagement with the first plate 2.

The second plate 4 also has an outer circumferential portion 4c formed by half blanking to protrude toward the first plate 2 side in the axial direction of the second plate 4. In the first embodiment, the height of half blanking of the outer circumferential portion 4c in the axial direction is set to about one-third to one-fourth of the thickness of the second plate 4. Since the second plate 4 is coaxially overlaid on the first plate 2, the axial direction of the second plate 4 is coincident with the axial direction of the first plate 2, that is, coincident with the direction along the center line O as shown in FIG. 2. Further, the second plate 4 has an annular recess portion 4e formed radially inward of the axially protruding outer circumferential portion 4c so as to be recessed relative to an inner surface 4d of the outer circumferential portion 4c. An inner surface 2g of the outer circumferential portion 2a of the first plate 2 facing the second plate 4 is brought into contact with a bottom surface of the annular recess portion 4e. For positioning of the second plate 4 in the circumferential direction, three indentations 4f are formed in the bottom surface of the annular recess portion 4e at circumferentially equally spaced positions.

The cover member 1 is cup-shaped. An axial hole 1a is formed in a center part of the cover member 1 such that the drive shaft is inserted through the axial hole 1a. The cover member 1 has a circumferential wall portion 1b and an annular outer flange portion 1c formed circumferentially around a distal end part of the circumferential wall portion 1b. The outer flange portion 1c of the cover member 1 is arranged on and fixed by e.g. laser welding to an axially outer surface of the second plate 4, with the circumferential wall portion 1b of the cover member 1 fitted on the outer circumferential surface of the annular flange portion 4a of the second plate 4.

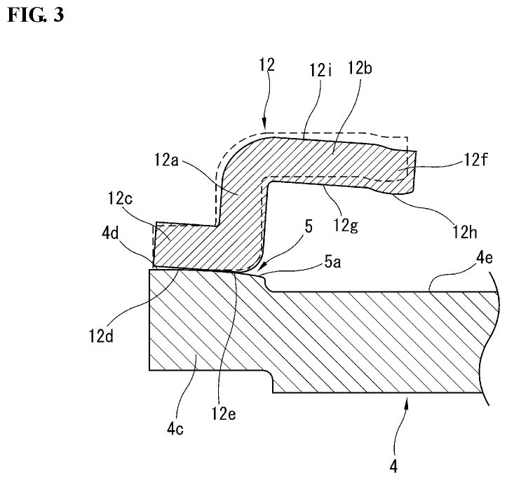

FIG. 3 is a sectional view of a part of the seat reclining device, in the vicinity of the outer circumferential portion 4c of the second plate 4, according to the first embodiment. In FIG. 3, the second plate 4 is partly omitted from illustration for the purpose of expressing inclination of the holder 12 more exaggeratedly than actual. Further, the position of the holder 12 before being pushed by the after-mentioned pushing device 15 (pushing portion 15b) is indicated by a broken line in FIG. 3.

As shown in FIG. 3, a depressed part 5 is provided on the inner surface 4d of the outer circumferential portion 4c of the second plate 4 at a position adjacent to the annular recess portion 4e. This depressed part 5 is formed by shear drop (sagging) due to half blanking of the outer circumferential portion 4c of the second plate 4, and is inclined in such a manner that the distance from the depressed part 5 to the holder 12 increases toward the radially inner side of the second plate 4. In the first embodiment, the depressed part 5 has a circular arc surface 5a that is slightly convex toward the after-mentioned inner flange portion 12b of the holder 12. The depressed part 5 may be formed by performing press forming on the inner surface 4d of the outer circumferential portion 4c and thereby directly deforming a part of the inner surface 4d of the outer circumferential portion 4c, rather than formed by shear drop due to half blanking of the outer circumferential portion 4c.

The seat reclining device according to the first embodiment further includes a metal bearing 6, a ring spring 7 (as a spring member), a pair of wedge-shaped members 9 and a guide plate 10 as shown in FIGS. 1 and 2.

The metal bearing 6 is in the form of a ring-shaped plain bearing etc. and is fitted into the inner circumferential surface of the annular flange portion 4a. The length of the metal bearing 6 in the axial direction is set substantially equal to the length of the large-diameter hole 4g of the second plate 4 (including the inner circumferential surface of the annular flange portion 4a) in the axial direction. As the axial length of the metal bearing 6 is set large in accordance with the axial length of the large-diameter hole 4g as mentioned above, the sliding area between the inner circumferential surface of the annular flange portion 4a and an outer circumferential surface of the guide plate 10 is made large so as to allow a decrease in surface pressure during sliding.

The ring spring 7 is arranged in the axial direction between a flange portion 3b of the drive bushing 3 and an inner surface of the cover member 1. Opposite end portions 7a of the ring spring 7 are formed to protrude toward the wedge-shaped members 9.

As shown in FIG. 2, there is an eccentric space 8 provided between an inner circumferential surface 6a of the metal bearing 6 and an outer circumferential surface 2h of the boss portion 2e of the first plate 2.

The wedge-shaped members 9 are disposed in the eccentric space 8, with base end portions 9a of the wedge-shaped members 9 being mutually opposed to each other. Each of the wedge-shaped member 9 has an arc shape that decreases in thickness from the base end portion 9a to a distal end portion 9b thereof. Semicircular spring fitting grooves 9c are respectively formed in end surfaces of the base end portions 9a of the wedge-shaped members 9.

As shown in FIGS. 1 and 2, the protruding end portions 7a of the ring spring 7 are fitted, from opposite sides, in the respective spring fitting grooves 9c of the wedge-shaped members 9 so that the wedge-shaped members 9 are biased circumferentially apart from each other by the ring spring 7 to maintain engagement of the external teeth 4b of the second plate 4 and the internal teeth 2c of the first plate 2 with no backlash therebetween. By the biasing force of the ring spring 7 and the wedge effect of the wedge-shaped members 9, the center-to-center distance (amount of eccentricity) between the external teeth 4b and the internal teeth 2c in the eccentric space 8 is increased. The second plate 4 is hence forced toward the upper side of FIG. 2, thereby allowing deep engagement of the external teeth 4b with the internal teeth 2c with no backlash. Consequently, the state where no play is present between the second plate 4 and the pair of wedge-shaped members 9 is maintained at a location between the boss portion 2e and the internal teeth 2c.

The guide plate 10 is disposed on one side of the wedge-shaped members 9 in the axial direction. In the eccentric space 8, the guide plate 10 is located on a side closer to the cover member 9; whereas the wedge-shaped members 9 are located on a side closer to the first plate 2.

The guide plate 10 is made of an iron-based metal material in a substantially circular arc shape. An inner circumferential surface 10a of the guide plate 10 is formed with a curvature radius approximately equal to that of the outer circumferential surface 2h of the boss portion 2e, whereas an outer circumferential surface 10b of the guide plate 10 is formed with a curvature radius approximately equal to that of the inner circumferential surface 6a of the metal bearing 6. The guide plate 10 is movable in the circumferential direction within the eccentric space 8 in the state where the center-to-center distance (amount of eccentricity) between the external teeth 4b and the internal teeth 2c is maintained constant. As shown in FIGS. 1 and 2, a circular arc-shaped protrusion 10c is formed integrally on the cover member 10-side of the guide plate 10; and a circular arc elongated hole 10d is formed along the circumferential direction in a substantially center part of the guide plate 10 such that the protruding end portions 7a of the ring spring 7 are inserted in the elongated hole 10d.

The drive bushing 3 is entirely formed by pressing of an iron-based metal material with a predetermined thickness, and is disposed between the guide plate 10 and the cover member 1 to push and rotate the wedge-shaped members 9 in the circumferential direction. As shown in FIGS. 1 and 2, the drive bushing 3 has: a cylindrical portion 3a rotatably supported in the boss portion 2e of the first plate 2; a flange portion 3b formed integrally on one axial end part (base end part) of the cylindrical portion 3a so as to cover side surfaces of the wedge-shaped members 9; a pushing portion 3c formed integrally on an outer circumferential side of the flange portion 3b so as to remove the wedge effect of the wedge-shaped members 9 by pushing the wedge-shaped members 9 from the circumferential side; and a wall portion 3d formed integrally in an annular shape on an inner circumferential surface of the other axial end part (distal end part) 3f of the cylindrical portion 3a.

The cylindrical portion 3a has an outer circumferential surface 3a formed with an outer diameter slightly smaller than an inner diameter of the inner circumferential surface 2j of the boss portion 2e such that the cylindrical portion 3a is rotatable within the boss portion 2e.

In the wall portion 3d of the drive bushing 3, female spline teeth 3g (as an annular internal toothed portion) are formed with a root diameter slightly smaller than the inner diameter of the cylindrical portion 3a. The drive bushing 3 is spline-connected to the output shaft of the electric motor by engagement of the female spline teeth 3g with male spline teeth formed on the outer circumference of the output shaft of the electric motor.

The flange portion 3b is ring-shaped. As mentioned above, the pushing portion 3c is formed on the outer circumferential side of the flange portion 3b. A circular arc groove 3h is formed in the flange portion 3b at a position radially opposite to the pushing portion 3c. The circular arc groove 3h overlaps in position with the circular arc elongated hole 10d of the guide plate 10 such that the protruding end portions 7a of the ring spring 7 are also inserted in the circular arc groove 3h from the axial direction.

In the first embodiment, the wedge-shaped members 9, the guide plate 10, the ring spring 7 and the drive bushing 3 constitute an eccentric drive mechanism 11 that changes the position of engagement of the internal teeth 2c and the external teeth 4b by eccentric rotation thereof and thereby causes rotation of the first plate 2 relative to the second plate 4.

The first plate 2 and the second plate 4 are held rotatably relative to each other by overlaying the first and second plates 2 and 4 with engagement of the internal teeth 2c and the external teeth 4b and welding the holder 12 to the outer circumferential portion 4c of the second plate 4. In the first embodiment, the welding is done by laser welding.

The holder 12 is made of an iron-based metal material in a cylindrical shape. As shown in FIGS. 1 to 3, the holder 12 has: a cylindrical portion 12a extending in the axial direction along the center line O of the first plate 2; an inner flange portion 12b extending radially inwardly from one axial end of the cylindrical portion 12a and opposed to the outer circumferential portion 2a of the first plate 2 in the axial direction; an outer flange portion 12c extending radially outwardly from the other axial end of the cylindrical portion 12a and fixed by welding to the outer circumferential portion 4c of the second plate 4. During manufacturing of the seat reclining device, the holder 12 is pushed by the after-mentioned pushing device 15 (pushing portion 15b) in such a manner as to force the inner flange portion 12b of the holder 12 toward the outer circumferential portion 2a of the first plate 2 and to force the outer flange portion 12c of the holder 12 toward the inner surface 4d of the second plate 4. Herein, the inner flange portion 12b is located axially apart from the outer circumferential portion 2a of the first plate 2 with a clearance 13 left therebetween; and the outer flange portion 12c is brought into contact with the inner surface 4d of the second plate 4 at a position radially outward of an outer circumferential surface of the cylindrical portion 12a. Consequently, a part of the cylindrical portion 12a radially inward of the outer circumferential surface of the cylindrical portion 12a is opposed to and faces the depressed part 5 via a clearance. When the holder 12 as a whole is pushed toward the second plate 4 side by the pushing portion 15b of the pushing device 15, the holder 12 is deformed to be inclined along the circular arc surface 5a and pushed into the depressed part 5. The welding is performed in such a state that the outer flange portion 12c is held in contact with the circular arc surface 5a. The outer flange portion 12c of the holder 12 is hence welded to the outer circumferential portion 4c of the second plate 4 in a slightly inclined posture relative to the second plate 2.

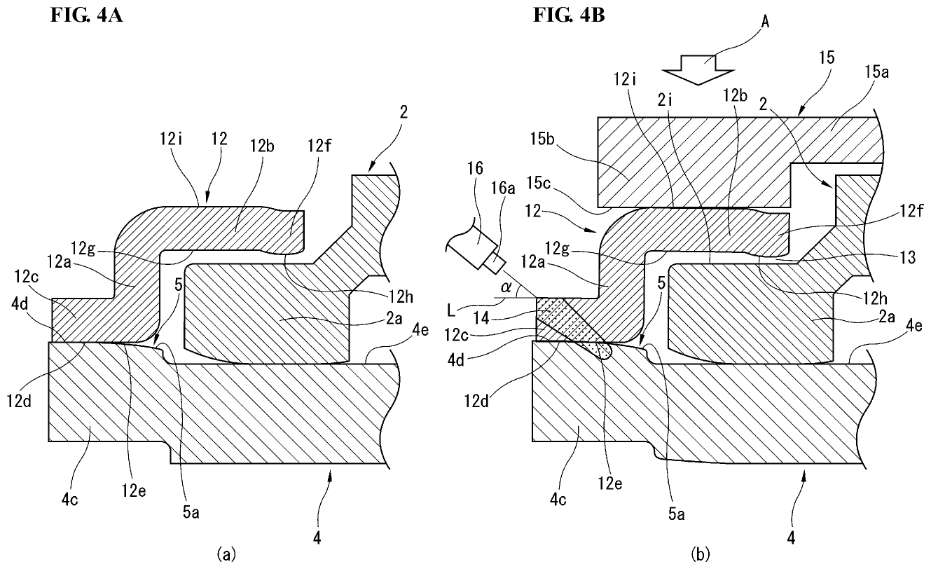

More specifically, the inner flange portion 12b is formed in an annular shape as a whole and is arranged such that an inner surface 12g of the inner flange portion 12b is opposed to and faces the first plate 2. As shown in FIG. 3, a distal end part 12f of the inner flange portion 12b is plastically deformed toward the second plate 4 side whereby a region of the inner surface 12g of the inner flange portion 12b is formed as a circular arc surface region 12h that is convex toward the first plate 2 side. There is a slight clearance 13 of e.g. about 0.1 mm left between the circular arc surface region 12h of the inner flange portion 12b of the holder 12 and an outer surface 2i of the outer circumferential portion 2a of the first plate 2 (see FIG. 4B) so as to restrict separation of the first plate 2 from the second plate 4 while allowing rotation of the first plate 2 relative to the second plate 4.

The outer flange portion 12c is also formed in an annular shape as a whole. The outer diameter of the outer flange portion 12c is set slightly smaller than the outer diameter of the second plate 4. Further, the length of the outer flange portion 12c in the radial direction of the holder 12 is set smaller than that of the inner flange portion 12b. Although shown exaggeratedly more than actual in FIG. 3, the outer flange portion 12c is deformed and slightly forced into the depressed part 5 by being pushed toward the second plate 4 side by the pushing portion 15b of the pushing device 15 such that a part 12e of the outer flange portion 12c located radially inward of the outer circumferential surface of the cylindrical portion 12a is inclined along and brought into contact with the circular arc surface 5a of the depressed part 5. In the state where the part 12e of the outer flange portion 12c located inward of the outer circumferential surface of the cylindrical portion 12a is held in contact with the circular arc surface 5a of the depressed part 5, the outer flange portion 12c is welded to the outer circumferential portion 4c of the second plate 4. In the first embodiment, the outer flange portion 12c is laser welded to the outer circumferential portion 4c of the second plate 4 by emitting a laser welding beam diagonally in a direction from the outer circumferential side of the outer flange portion 12c toward the depressed part 5 in such a manner that the laser beam passes through a boundary between the part 12e of the second plate 4-side surface 12d of the outer flange portion 12c adjacent to the outer circumferential surface of the cylindrical portion 12a and the circular arc surface 5a of the depressed part 5. In FIG. 2, welding marks (welds) 14 formed by laser welding are shown by dotted hatching.

FIGS. 4A and 4B are respectively schematic views of an arrangement step and a pushing/laser welding step in a process of manufacturing the seat reclining device by means of a seat reclining device manufacturing system.

The seat reclining device manufacturing system includes: a support stand (not shown) for supporting thereon the second plate 4 with the first plate 2 and the holder 12; a pushing device 15 for pushing the inner flange portion 12b of the holder 12 toward the first plate 2 side; and a laser welding device 16 for welding the outer flange portion 12c of the holder 12 to the outer circumferential portion 4c of the second plate 4.

As shown in FIG. 4A, the support stand is configured to support and hold the second plate 4 with the first plate 2 and the holder 12 in such a manner that the depressed part 5 of the second plate 4 is open toward the upper side, and is rotatable in the circumferential direction about the center of the second plate 4.

The pushing device 15 has a circular plate-shaped base portion 15a and an annular pushing portion 15b protruding from an outer circumferential edge part of the base portion 15a toward the inner flange portion 12b of the holder 12. The base portion 15a is connected to an air cylinder of known type so as to be movable closer to or away from the first plate 12 and the holder 12. The pushing portion 15b is formed with a radial dimension enough to push the outer surface 12i of the inner flange portion 12b except the distal end part 12f, and has an annular pushing surface 15c to push the outer surface 12i of the inner flange portion 12b toward the outer circumferential portion 2a of the first plate 2. The pushing portion 15 does not necessarily push the entire outer surface 12i of the inner flange portion 12b and may alternatively be configured to push only an outer circumferential region of the outer surface 12i of the inner flange portion 12b (i.e. a part of the outer surface 12i adjacent to the cylindrical portion 12a).

The laser welding device 16 has an emission unit 16a that emits a laser. The emission unit 16a is arranged in a fixed position on the outer circumferential side of the holder 12 such that the emission unit 16a (more specifically, the laser beam emitted from the emission unit 16a) is inclined at a predetermined inclination angle α relative to a line L parallel to the inner surface 4d of the outer circumferential portion 4c of the second plate 4.

The manufacturing process of the seat reclining device will be explained in more detail below.

In the arrangement step shown in FIG. 4(A), the first plate 2 and the second plate 4 are overlaid on each other with engagement of the internal teeth 2c of the first plate 2 and the external teeth 4b of the second plate 4; and the holder 12 is disposed on the outer circumferential portion 4c of the second plate 4. The thus-obtained subassembly of the second plate 4 with the first plate 2 and the holder 12 is placed on the support stand. After the placement of the subassembly, the inner flange portion 12b of the holder 12 is in parallel with the outer circumferential portion 2a of the first plate 2. In this state, a clearance larger than the above-mentioned slight clearance 13 is left between the inner flange portion 12b of the holder 12 and the outer circumferential portion 2a of the first plate 2.

In the subsequent pushing step before the laser welding step, the pushing surface 15c of the pushing portion 15b of the pushing device 15 is pushed against the outer surface 12i of the inner flange portion 12b of the holder 12 as shown by arrow A in FIG. 4(B). As a result, the part 12e of the side surface 12d of the outer flange portion 12c is pushed into the depressed part 5 and brought into contact with the circular arc surface 5a of the depressed part 5. By this pushing operation, the inner flange portion 12b of the holder 12 is brought closer to the outer circumferential portion 2a of the first plate 2 until the slight clearance 13 is formed between the inner flange portion 12b of the holder 12 and the outer circumferential portion 2a of the first plate 2.

Then, the outer flange portion 12c of the holder 12 is laser welded to the outer circumferential portion 4c of the second plate 4 in the laser welding step by intermittently emitting the laser beam from the laser emission unit 16a while rotating the support stand on which the second plate 4 is placed with the first plate 2 and the holder 12. After the laser welding, there remains a plurality of welding marks (welds) 14 at equally spaced positions in the circumferential direction of the second plate 4. Herein, each of the welding marks (welds) 14 is inclined at an angle α relative to the line L.

As described above, the outer flange portion 12c of the holder 12 is welded to the outer circumferential portion 4c of the second plate 4 in the state where the outer flange portion 12c is pushed into the depressed part 5 in the first embodiment. More specifically, the outer flange portion 12c of the holder 12 is welded to the outer circumferential portion 4c of the second plate 4 in the state where the holder 12 is pushed by the pushing device 15 in such a manner as to bring the part 12e of the side surface 12d of the outer flange portion 12c into contact with the circular arc surface 5a of the depressed part 5 and to bring the circular arc surface region 12h of the inner flange portion 12b closer to the outer surface 2i of the outer circumferential portion 2a of the first plate 2 via the clearance 13. In other words, the laser welding is performed in the state where dimensional variations of the first plate 2, the second plate 4 and the holder 12 are absorbed by the depressed part 5. Consequently, the ideal slight clearance 13 is ensured between the circular arc surface 12h of the inner flange portion 12b and the outer surface 2i of the outer circumferential portion 2a of the first plate 2. It is therefore possible to achieve stable welding of the outer flange portion 12c of the holder 12 to the outer circumferential portion 4c of the second plate 4 while ensuring the ideal slight clearance 13 between the inner flange portion 12b of the holder 12 and the outer circumferential portion 2a of the first plate 2.

Further, the laser welding of the outer flange portion 12c of the holder 12 to the outer circumferential portion 4c of the second plate 4 is performed by emitting the laser beam diagonally from the outer circumferential side of the outer flange portion 12c toward the depressed part 5. In the state that the outer flange portion 12c is pushed into the depressed part 5, the boundary between the part 12e of the outer flange portion 12c and the circular arc surface 5a of the depressed part 5 is inclined relative to the inner surface 4d of the outer circumferential portion 4c of the second plate 4 upon contact of the part 12e with the circular arc surface 5a. By performing the laser welding diagonally on such an inclined boundary, the outer flange portion 12c of the holder 12 is easily welded to the outer circumferential portion 4c of the second plate 4 at the position that the part 12e of the outer flange portion 12c of the holder 12 is pushed in the depressed part 5.

In the first embodiment, the depressed part 5 is formed with the circular arc surface 5a that is convex toward the inner flange portion 12b side of the holder 12. Thus, the outer flange portion 12c is inclined along the circular arc surface 5a so as to decrease the clearance between the circular arc surface 5a and the outer flange portion 12c. This enables stable laser welding of the outer flange portion 12c.

Furthermore, the outer circumferential portion 4c of the second plate 4 is formed by half blanking in such a manner as to protrude toward the first plate 2 side; and the depressed part 5 is formed by shear drop (sagging) due to half blanking of the outer circumferential portion 4c. In the first embodiment, the height of half blanking of the outer circumferential portion 4c in the axial direction is set to about one-third to one-fourth of the thickness of the second plate 4 in the axial direction. As the depressed part 5 is formed by shear drop (sagging) due to half blanking of the outer circumferential portion 4c as mentioned above, it is possible to form the depressed part 5 more easily than by any other technique such as cutting.

When the height of half blanking of the outer circumferential portion 4c in the axial direction is set larger than the above setting, it is not possible to ensure the sufficient axial length of the cylindrical portion 12a of the holder 12 so that, when the inner flange portion 12b is pushed toward the first plate 2 side, the holder 12 itself becomes easy to elastically deform. This raises a possibility that the outer flange portion 12b cannot be sufficiently pushed into the depressed part 5. In view of compatibility between ensuring the axial length of the cylindrical portion 12a of the holder 12 and forming the depressed part 5 by shear drop (sagging) due to half blanking of the outer circumferential portion 4c, it is preferable that the height of half blanking of the outer circumferential portion 4c in the axial direction is set to about one-third to one-fourth of the thickness of the second plate 4 in the axial direction.

Next, a seat reclining device according to the second embodiment of the present invention will be explained below.

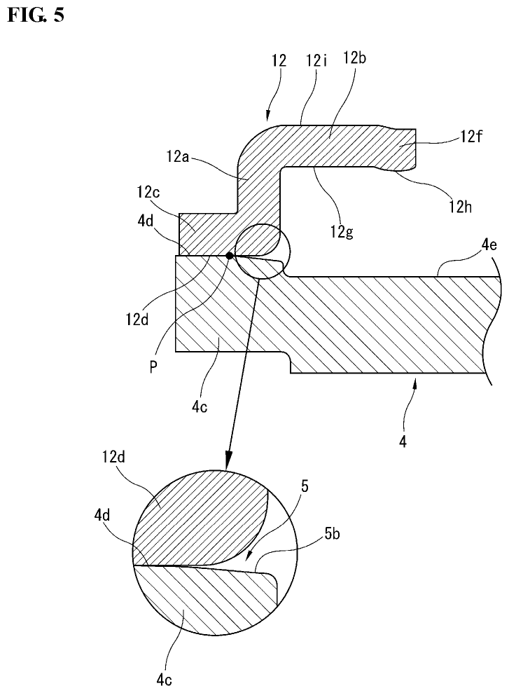

FIG. 5 is a sectional view of a part of the seat reclining device, in the vicinity of the outer circumferential portion 4c of the second plate 4, according to the second embodiment.

The second embodiment is different from the first embodiment, in that the depressed part 5 has an inclined surface 5b that is gradually inclined in such a manner that the distance from the holder 12 to the depressed part 5 (inclined surface 5b) increases toward the radially inner side of the second plate 4. The inclined surface 5b is formed by performing press forming etc. on the outer circumferential portion 4c of the second plate 4 and thereby directly deforming the inner surface 4d of the outer circumferential portion 4c. As in the case of the first embodiment, the point P on the boundary between the inclined surface 5b and the inner surface 4d of the outer circumferential portion 4c is located radially outward of the outer circumferential surface of the cylindrical portion 12a in the second embodiment. When the inner flange portion 12c of the holder 12 is pushed toward the first plate 2 side, the point P serves as a fulcrum of inclination (pushing) of the outer flange portion 12c into the depressed part 5. During the laser welding, welding marks are formed to pass through the fulcrum.

As described above, the depressed part 5 is formed with the inclined surface 5b that is gradually inclined in such a manner that the distance from the holder 12 to the depressed part 5 (inclined surface 5b) increases toward the radially inner side of the second plate 4 in the second embodiment. Even when the depressed part 5 is formed with such an inclined surface 5b, it is possible to achieve stable weld fixing of the outer flange portion 12c of the holder 12 to the outer circumferential portion 4c of the second plate 4 while ensuring the ideal slight clearance 13 between the inner flange portion 12b of the holder 12 and the outer circumferential portion 2a of the first plate 2 as in the case of the first embodiment.

Although the present invention has been described above with reference to the specific embodiments, the above-described specific embodiments are intended to facilitate understanding of the present invention and are not intended to limit the present invention thereto. Various changes and modifications of the above embodiments can be made as appropriate without departing from the scope of the present invention.

For example, it is alternatively feasible to form the internal teeth on the second plate 4 and form the external teeth on the second plate 2 although the internal teeth 2c and the external teeth 4b are formed on the first plate 2 and the second plate 4, respectively, in the above embodiments. In such an alternative embodiment, the outer circumferential portion 2a is welded to the outer flange portion 12c of the holder 12.

The entire contents of Japanese Patent Application No. 2023-047439 (filed on Mar. 24, 2023) are herein incorporated by reference. The scope of the present invention is defined with reference to the following claims.

1. A seat reclining device comprising:
a first plate having a plurality of internal teeth formed in an axial direction on an annular inner circumferential surface thereof;
a second plate overlaid on the first plate and having a plurality of external teeth formed on an annular outer circumferential surface thereof and engaged with the internal teeth, a number of the external teeth being smaller by one or two than a number of the internal teeth;
a ring-shaped holder fixed by welding to an outer circumferential portion of one of the first and second plates, while being opposed to an outer circumferential portion of the other of the first and second plates in the axial direction, so as to restrict separation of the other of the first and second plates from the one of the first and second plates; and
an eccentric drive mechanism eccentrically rotatable to change a position of engagement of the internal teeth and the external teeth and thereby cause rotation of the other of the first and second plates relative to the one of the first and second plates,
the holder comprising: a cylindrical portion extending in the axial direction; an inner flange portion extending radially inwardly from one axial end of the cylindrical portion and opposed to the other of the first and second plates; and an outer flange portion extending radially outwardly from the other axial end of the cylindrical portion and welded to the one of the first and second plates,
wherein the outer circumferential portion of the one of the first and second plates has, formed on a surface thereof opposed to and facing the outer flange portion of the holder, a depressed part inclined in such a manner that a distance from the holder to the depressed part in the axial direction increases toward a radially inner side, and
wherein the outer flange portion of the holder is welded to the outer circumferential portion of the one of the first and second plates in a state of being pushed into the depressed part.

2. The seat reclining device according to claim 1,
wherein the outer flange portion of the holder is laser welded to the outer circumferential portion of the one of the first and second plates by emitting a laser beam diagonally from an outer circumferential side of the outer flange portion toward the depressed part.

3. The seat reclining device according to claim 1,
wherein the depressed part has either an circular arc surface that is convex toward the holder, or an inclined surface that is inclined in such a manner that the distance from the holder in the axial direction increases toward the radially inner side.

4. The seat reclining device according to claim 1,
wherein the outer circumferential portion of the one of the first and second plates is formed by half blanking in such a manner as to protrude toward the other of the first and second plates,
wherein the depressed part is formed by shear drop due to the half blanking of the outer circumferential portion of the one of the first and second plates, and
wherein a height of the half blanking of the outer circumferential portion in the axial direction is one-third to one-fourth of a thickness of the one of the first and second plates in the axial direction.

5. The seat reclining device according to claim 1,
wherein the internal teeth and the external teeth are each formed by half blanking in the axial direction.

6. A manufacturing method of a seat reclining device,
the seat reclining device comprising:
a first plate having a plurality of internal teeth formed in an axial direction on an annular inner circumferential surface thereof;
a second plate overlaid on the first plate and having a plurality of external teeth formed on an annular outer circumferential surface thereof and engaged with the internal teeth, a number of the external teeth being smaller by one or two than a number of the internal teeth;
a ring-shaped holder fixed by welding to an outer circumferential portion of one of the first and second plates, while being opposed to an outer circumferential portion of the other of the first and second plates in the axial direction, so as to restrict separation of the other of the first and second plates from the one of the first and second plates; and
an eccentric drive mechanism eccentrically rotatable to change a position of engagement of the internal teeth and the external teeth and thereby cause rotation of the other of the first and second plates relative to the one of the first and second plates,
the holder comprising: a cylindrical portion extending in the axial direction; an inner flange portion extending radially inwardly from one axial end of the cylindrical portion and opposed to the other of the first and second plates; and an outer flange portion extending radially outwardly from the other axial end of the cylindrical portion and welded to the one of the first and second plates,
the manufacturing method comprising:
pushing the outer flange portion of the holder toward the outer circumferential portion of one of the first and second plates; and
welding the outer flange portion of the holder to the outer circumferential portion of the one of the first and second plates,
wherein the outer circumferential portion of the one of the first and second plates has, formed on a surface thereof opposed to and facing the outer flange portion of the holder, a depressed part inclined in such a manner that a distance from the holder to the depressed part in the axial direction increases toward a radially inner side,
wherein the pushing is performed to push the outer flange portion into the depressed part, and
wherein the welding is performed in a state that the outer flange portion is pushed into the depressed part.

7. The manufacturing method of the seat reclining device according to claim 6, wherein, in the welding, the outer flange portion of the holder is laser welded to the outer circumferential portion of the one of the first and second plates by emitting a laser beam diagonally from an outer circumferential side of the outer flange portion toward the depressed part.
